(19) United States
(12) Patent Application Publication
(10) Pub. No.: US 2017/0057637 A1
(43) Pub. Date: Mar. 2, 2017

(54) CREW REST SYSTEMS FOR AIRCRAFT AND RELATED METHODS

(71) Applicant: The Boeing Company, Chicago, IL (US)

(72) Inventor: Bobbie Lee Cole, Mukilteo, WA (US)

(21) Appl. No.: 14/839,780

(22) Filed: Aug. 28, 2015

(51) Int. Cl. B64D 11/00; B64C 1/20

(52) U.S. Cl. CPC B64D 11/00; B64C 1/20; B64D 2011/0076

(57) ABSTRACT

Presently disclosed crew rest systems for an aircraft may provide an upper crew rest positioned in the crown portion of the aircraft and a lower crew rest positioned in the cargo area of the aircraft, with both the upper crew rest and the lower crew rest being accessible from a single entrance enclosure. Each of the upper crew rest and lower crew rest may include one or more bunks, or locations for a crew member to rest (e.g., lie down). Such crew rest systems may be customizable and/or modular, such that the number of bunks in the upper crew rest and/or lower crew rest may be selectively increased or decreased. In some examples, the lower crew rest may be selectively removable, and replaced with a cargo pallet or cargo container. Related methods of customizing such crew rest systems are also disclosed.

### FIELD

The present disclosure relates to crew rest systems for aircraft, and related methods.

### BACKGROUND

On longer flights, it is often necessary to provide room on an aircraft for flight crew and cabin crew (e.g., the pilot and flight attendants) to rest during the flight. However, space for such crew rest areas may be quite limited and dependent upon the size and configuration of the particular aircraft. Smaller airplanes, and those with limited space in the crown (above the main passenger cabin of the aircraft), may be restricted in flight duration if there is not enough space for the required or desired number of crew rest stations. Often, such aircraft will have separate crew rest stations for the flight crew and the cabin crew, with each crew rest station accessible by a separate entrance enclosure. Having multiple entrance enclosures may decrease the space available in the main cabin, thereby decreasing the number of passenger seats on a particular aircraft, which in turn may decrease revenue for the airline. Attempts to design new crew rest stations have often resulted in bizarre aesthetics and inconvenient manufacturing processes.

### SUMMARY

Presently disclosed crew rest systems and related methods may be configured to provide increased efficiency in passenger aircrafts. For example, a single entrance enclosure may allow access to both an upper crew rest positioned in the crown of the aircraft, as well as a lower crew rest positioned in the cargo area of the aircraft. Accessing both the upper crew rest and the lower crew rest from a single entrance enclosure may enable a more efficient use of space and may be configured to increase the number of passenger seats possible in a given aircraft.

One example of a crew rest system for an aircraft according to the present disclosure may include an upper crew rest configured to be positioned within a crown portion of the aircraft, a lower crew rest configured to be positioned within a cargo area of the aircraft, and an entrance enclosure accessible from a main cabin of the aircraft, the entrance enclosure being configured to adjoin the upper crew rest and the lower crew rest, and to selectively provide access to the upper crew rest and the lower crew rest. The upper crew rest may include at least one upper bunk configured for a crew member to rest therein and the lower crew rest may include at least one lower bunk configured for a crew member to rest therein.

In some examples, the crew rest system may be modular and/or customizable, such that more or fewer bunks selectively may be provided in the upper crew rest and/or lower crew rest, as desired for a given flight. Presently disclosed methods of providing such a crew rest for a flight crew of an aircraft may include providing a crew rest system according to the present disclosure, and ensuring that the crew rest system provides the desired number of crew rests for a given flight of the aircraft. In some examples, if fewer crew rest bunks are desired for a given flight or aircraft, then, for example, the lower crew rest may be removed from the crew rest system and replaced with a cargo pallet or cargo container. On the other hand, if more crew rest bunks are desired for a given flight or aircraft, additional bunks may be added, or modules of the crew rest system may be replaced with different modules having an increased number of bunks.

### BRIEF DESCRIPTION OF THE DRAWINGS

FIG. 1 is a schematic, side elevation view of illustrative, non-exclusive examples of an aircraft that may include a crew rest system according to the present disclosure.

FIG. 2 is a schematic view of illustrative, non-exclusive examples of crew rest systems according to the present disclosure.

FIG. 3 is a side elevation, schematic view of illustrative, non-exclusive examples of a crew rest system according to the present disclosure, positioned within a schematic representation of an aircraft.

FIG. 4 is a side elevation, schematic view of illustrative, non-exclusive examples of a crew rest system according to the present disclosure, positioned within a schematic representation of an aircraft.

FIG. 5 is a perspective view of one example of a crew rest system according to the present disclosure.

FIG. 6 is a perspective view of one example of a crew rest system according to the present disclosure.

FIG. 7 is a partial, perspective view of one example of a crew rest system according to the present disclosure, showing upper and lower secondary egresses.

FIG. 8 is a partial, perspective view of one example of a crew rest system according to the present disclosure, showing an articulating door in a closed position.

FIG. 9 is a partial, perspective view of the crew rest system of FIG. 8, with the articulating door in an open position.

FIG. 10 is a partial, perspective view of one example of a crew rest system according to the present disclosure, with the upper access structure and lower access structure at least partially visible.

FIG. 11 is a schematic, block diagram view of illustrative, non-exclusive examples of methods of providing a crew rest for a flight crew of an aircraft, according to the present disclosure.

### DESCRIPTION

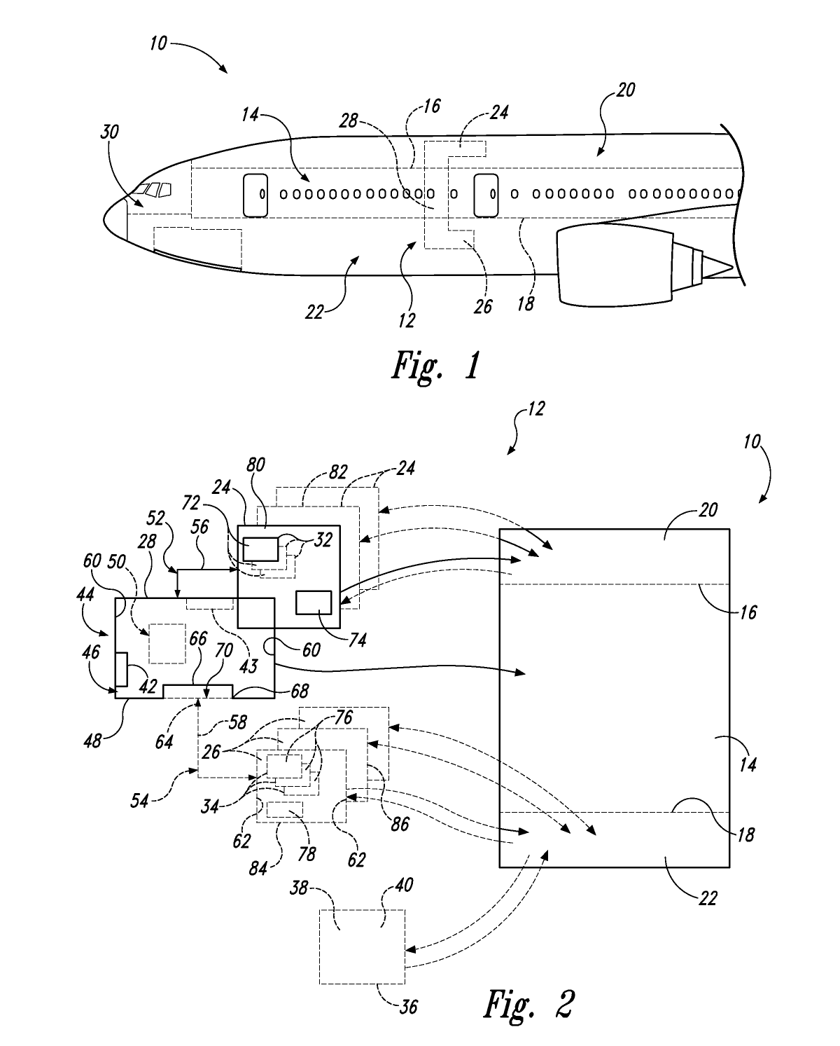

Presently disclosed crew rest systems may be utilized in aircraft where space is at a premium, and may provide a crew rest system with a single entrance enclosure that allows access to an upper crew rest above the main cabin and a lower crew rest below the main cabin. FIG. 1 illustrates a generic side view of an aircraft 10, which may include a crew rest system 12 according to the present disclosure. Aircraft 10 may be any type of aircraft, but may be, for example, a passenger aircraft configured for flights of longer than 8 hours. Aircraft 10 may include a main cabin 14 (also referred to herein as a “passenger cabin” or “main passenger cabin”) which may include a plurality of passenger seats therein, main cabin 14 being bounded from above by a main cabin ceiling 16 and below by a main cabin floor 18. A crown portion 20 may be positioned above main cabin ceiling 16, and a cargo area 22 may be positioned below main cabin floor 18. Crew rest system 12 may include an upper crew rest 24 configured to be positioned within crown portion 20 and a lower crew rest 26 configured to be positioned within cargo area 22. An entrance enclosure 28 may be accessible from main cabin 14, and may be configured to selectively provide access to crew rest system 12 (e.g., access to upper crew rest 24 and lower crew rest 26). FIG. 1 generally illustrates entrance enclosure 28 positioned in the forward portion of aircraft 10, however, entrance enclosure 28 of presently disclosed crew rest systems 12 may be positioned anywhere in main cabin 14, such as adjacent a cockpit 30, or towards the rear of aircraft 10 in some examples.

FIG. 2 illustrates a schematic view of crew rest systems 12 according to the present disclosure. Generally, in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

As shown in FIG. 2, upper crew rest 24 may include one or more upper bunks 32 and lower crew rest 26 may include one or more lower bunks 34, each of the upper bunks 32 and lower bunks 34 being configured for a crew member to rest therein. Entrance enclosure 28 may be coupled to upper crew rest 24 and/or lower crew rest 26. In some crew rest systems 12, entrance enclosure 28 may be removably coupled to upper crew rest 24 and/or lower crew rest 26, which may enable crew rest system 12 to be modular and/or customizable, such that one or more of upper crew rest 24 and lower crew rest 26 may be removable from entrance enclosure 28, and replaced with a different respective upper crew rest 24 or lower crew rest 26, or with a different cargo structure 36, such as a cargo pallet 38 or cargo container 40.

Entrance enclosure 28 may be accessible from main cabin 14 of aircraft 10, such as through one or more walk-through doors 42. Additionally or alternatively, entrance enclosure 28 may be accessible from cockpit 30 (FIG. 1) of aircraft 10, such as through one or more walk-through doors 42. In some examples, a first walk-through door 42 may provide access to entrance enclosure 28 from main cabin 14, while a second walk-through door 42 may provide access to entrance enclosure 28 from cockpit 30. In some examples, entrance enclosure 28 may be a standard entrance enclosure that is modified to receive upper crew rest 24 and lower crew rest 26.

In some examples, entrance enclosure 28 may include a stowage area 43 that may be configured to provide a space for storing a galley cart, emergency equipment, and/or any other desired equipment or items. Stowage area 43 may be accessible from inside entrance enclosure 28 and/or from accessible from a position exterior to entrance enclosure 28.

Entrance enclosure 28 may include an upper portion 44 and a lower portion 46, where lower portion 46 may be positioned opposite upper portion 44. Upper crew rest 24 may be coupled to upper portion 44 of entrance enclosure 28, and/or lower crew rest 26 may be coupled to lower portion 46 of entrance enclosure 28. In some examples, lower portion 46 of entrance enclosure 28 may be positioned adjacent floor 18 of main cabin 14 of aircraft 10. In some examples, entrance enclosure 28 may include a base 48 adjacent lower portion 46, base 48 being affixed to and/or positioned on floor 18. Additionally or alternatively, entrance enclosure 28 may be configured and positioned to extend from floor 18 to ceiling 16 of main cabin 14, with upper crew rest 24 extending into crown portion 20 of aircraft 10, above ceiling 16, and lower crew rest extending into cargo area 22 of aircraft 10, below floor 18. Thus, entrance enclosure 28 may be configured to provide access to areas (e.g., upper crew rest 24 and lower crew rest 26) where crew members can lie down and rest, without decreasing the number of passenger seats in main cabin 14 (e.g., by positioning upper crew rest 24 and lower crew rest 26 in areas outside main cabin 14). Entrance enclosure 28 may include a storage area 50 (e.g., a closet, a cubby, a shelf, etc.) configured to receive one or more personal articles from a crew member while the crew member is resting in upper crew rest 24 or lower crew rest 26.

Entrance enclosure 28 may be configured to adjoin upper crew rest 24 and lower crew rest 26. For example, entrance enclosure 28 may be configured to provide a path for a crew member to move from upper crew rest 24 to lower crew rest 26 (and vice versa) without exiting entrance enclosure 28. Thus, entrance enclosure 28 may be configured to provide a single, joint entrance for upper crew rest 24 and lower crew rest 26. For example, crew rest system 12 may include an upper access structure 52 configured to provide access from entrance enclosure 28 to upper crew rest 24, and a lower access structure 54 configured to provide access from entrance enclosure 28 to lower crew rest 26. For example, upper access structure 52 and/or lower access structure 54 may include a ladder, stairs, ramps, bars, rungs, steps, ropes, handles, grips, recesses, and/or any other structures that may allow a crew member to access lower crew rest 26 or upper crew rest 24 from entrance enclosure 28.

In specific examples, upper access structure 52 may be an upper ladder 56, and lower access structure 54 may be a lower ladder 58. Upper access structure 52 (e.g., upper ladder 56) may be coupled to an interior wall 60 of entrance enclosure 28, in some examples, and may lead directly to upper crew rest 24 (e.g., a crew member may be able to climb directly into upper crew rest 24 from entrance enclosure 28, via upper access structure 52). In some examples, upper access structure 52 may be formed integrally with entrance enclosure 28. For example, upper access structure 52 may include one or more rungs or bars permanently secured to one or more interior walls 60 of entrance enclosure 28, and/or one or more recesses formed in one or more interior walls 60 that may serve as receiving areas for a crew member's foot and hands as they climb up into upper crew rest 24 or down from upper crew rest 24.

Lower access structure 54 may be coupled to entrance enclosure 28, and/or may be coupled to lower crew rest 26. In some examples, lower access structure 54 may be formed integrally with lower crew rest 26 (e.g., lower access structure 54 may include one or more rungs or bars fixedly secured to one or more lower interior walls 62 of lower crew rest 26, and/or one or more recesses formed in one or more lower interior walls 62 that may serve as receiving areas for a crew member's foot and hands as they climb down into lower crew rest 26 or up from lower crew rest 26 into entrance enclosure 28). An upper end 64 of lower access structure 54 may extend into entrance enclosure 28, may be positioned adjacent entrance enclosure 28, and/or may be removably coupled to entrance enclosure 28. In some examples, lower access structure 54 may be configured to extend from base 48 of entrance enclosure 28, down into lower crew rest 26.

Entrance enclosure 28 may include an articulating door 66, said articulating door 66 being configured to selectively block or provide access through base 48 and/or lower portion 46 of entrance enclosure 28 (e.g., through an access hole 70 of an interior floor 68 of entrance enclosure 28). Articulating door 66 may be configured to selectively provide access from entrance enclosure 28 to lower crew rest 26, lower access structure 54, cargo area 22 of aircraft 10, and/or cargo structure 36, depending on the respective configuration of crew rest system 12. For example, articulating door 66 may be selectively openable such that a crew member may descend through articulating door 66 and down lower access structure 54 into lower crew rest 26. Articulating door 66 may be configured to bias into a closed position when not in use (e.g., articulating door 66 may be spring-loaded), thereby blocking access hole 70 formed in base 48 of entrance enclosure 28, such that a crew member may stand on and be supported by articulating door 66 when in the closed position. Thus, when articulating door 66 is in the closed position, it may be configured to block lower crew rest 26 and/or lower access structure 54. In some examples, articulating door 66 may take the form of a sliding door, which may be opened, for example, by sliding it into a recess formed in base 48 of entrance enclosure 28.

Upper crew rest may be configured for placement adjacent an interior inner mold line of aircraft 10. Upper crew rest 24 may be formed integrally with entrance enclosure 28. In other examples, upper crew rest 24 may be selectively removable from entrance enclosure 28. Upper crew rest 24 may include one or more upper bunks 32 that are configured to be positioned within crown portion 20 of aircraft 10. Each upper bunk 32 may include an upper mattress portion 72, which may be a padded area or bedding, suitable for a crew member to lie on and rest. Each upper bunk 32 and upper mattress portion 72 may be sized to accommodate an adult crew member, such that the crew member may comfortably be able to rest in a seated, reclined, supine, or prone position. Upper crew rest 24 (e.g., each upper bunk 32 of upper crew rest 24) may include one or more upper secondary egresses 74, each of which may be configured to allow a crew member to exit upper crew rest 24 (e.g., a respective upper bunk 32) without re-entering entrance enclosure 28. In other words, upper secondary egress 74 may be configured as an emergency exit, which may allow egress from upper crew rest 24, separately from entrance enclosure 28. For example, upper secondary egress 74 may be an upper escape hatch that allows a crew member to exit from upper crew rest 24 into an interior portion of aircraft 10 (e.g., into main cabin 14 or into a stowage bin area of aircraft 10). Thus, upper secondary egress 74 may be configured to allow access from upper crew rest 24 into main cabin 14 of aircraft 10.

In some crew rest systems 12, the entire lower crew rest 26 may be positioned below floor 18 of main cabin 14 of aircraft 10. Lower crew rest 26 may be formed integrally with entrance enclosure 28. In other examples, lower crew rest 26 may be selectively removable from entrance enclosure 28. Lower crew rest 26 may include one or more lower bunks 34 that are configured to be positioned within cargo area 22 of aircraft 10. For example, lower crew rest 26 may be configured to fit within a standard cargo container volume or footprint. Lower crew rest 26 may be selectively removable from cargo area 22, such that a cargo container 40 or cargo pallet 38 may be placed in cargo area 22, at least partially underneath entrance enclosure 28, in place of lower crew rest 26, when desired. In other words, removal of lower crew rest 26 from aircraft 10 may permit placement of one or more of a cargo pallet 38 and a cargo container 40 in the space where lower crew rest 26 was located before its removal. Lower crew rest 26 may be configured to be secured within cargo area 22 using a standard cargo restraint (e.g., using hardware that may also be used to secure a cargo container or cargo pallet in the same location). In some crew rest systems 12, lower crew rest 26 may be configured to provide access to cargo area 22 of aircraft 10, through lower crew rest 26.

Each lower bunk 34 may include a lower mattress portion 76, which may be a padded area or bedding, suitable for a crew member to lie on and rest. Each lower bunk 34 and lower mattress portion 76 may be sized to accommodate an adult crew member, such that the crew member may comfortably be able to rest in a seated, reclined, supine, or prone position. Lower crew rest 26 (e.g., each lower bunk 34 of lower crew rest 26) may include one or more lower secondary egresses 78, each of which may be configured to allow a crew member to exit lower crew rest 26 (e.g., a respective lower bunk 34) without re-entering entrance enclosure 28. In other words, lower secondary egress 78 may be configured as an emergency exit, which may allow egress from lower crew rest 26, separately from entrance enclosure 28. For example, lower secondary egress 78 may be a lower escape hatch that allows a crew member to exit from lower crew rest 26 into an interior portion of aircraft 10 (e.g., into main cabin 14, via floor 18) or into cargo area 22. Thus, lower secondary egress 78 may be configured to allow access from lower crew rest 26 into main cabin 14 of aircraft 10.

Crew rest systems 12 may be configured to be selectively customizable such that the number of upper bunks 32 and the number of lower bunks 34 may be selectively changed (e.g., increased or decreased). In some examples, crew rest system 12 may be modular, such that upper crew rest 24 may be selectively removable from entrance enclosure 28 and replaced with a different respective upper crew rest 24. For example, upper crew rest 24 of crew rest system 12 may include a first upper crew rest 80 and a second upper crew rest 82, such that first upper crew rest 80 and second upper crew rest 82 may be interchangeable with one another, such that when one is removed from entrance enclosure 28, the other may be coupled thereto. In other words, crew rest system 12 may be configured such that one of first upper crew rest 80 and second upper crew rest 82 is coupled to entrance enclosure 28 at a time, each of first upper crew rest 80 and second upper crew rest 82 being selectively removable from entrance enclosure 28 so that the other of first upper crew rest 80 and second upper crew rest 82 may alternately be coupled to entrance enclosure 28, adjacent upper portion 44 of entrance enclosure 28. First upper crew rest 80 may be different from second upper crew rest 82 in at least one of shape, size, orientation, and number of upper bunks 32. Additionally or alternatively, crew rest systems 12 may be modular and customizable in the sense that one or more upper bunks 32 may be added to or removed from a given upper crew rest 24.

Similarly, crew rest system 12 may be modular, such that lower crew rest 26 may be selectively removable from entrance enclosure 28 and replaced with a different respective lower crew rest 26. For example, lower crew rest 26 of crew rest system 12 may include a first lower crew rest 84 and a second lower crew rest 86, such that first lower crew rest 84 and second lower crew rest 86 may be interchangeable with one another, such that when one is removed from entrance enclosure 28, the other may be coupled thereto. In other words, crew rest system 12 may be configured such that one of first lower crew rest 84 and second lower crew rest 86 is coupled to entrance enclosure 28 at a time, each of first lower crew rest 84 and second lower crew rest 86 being selectively removable from entrance enclosure 28 so that the other of first lower crew rest 84 and second lower crew rest 86 may alternately be coupled to entrance enclosure 28, adjacent lower portion 46 of entrance enclosure 28. First lower crew rest 84 may be different from second lower crew rest 86 in at least one of shape, size, orientation, and number of lower bunks 34. Additionally or alternatively, removal of lower crew rest 26 from entrance enclosure 28 may enable placement of cargo structure 36 in the location where lower crew rest 26 was removed, instead of replacement with a different respective lower crew rest. Additionally or alternatively, crew rest systems 12 may be modular and customizable in the sense that one or more lower bunks 34 may be added to or removed from a given lower crew rest 26.

Thus, presently disclosed crew rest systems 12 may enable reconfiguration and customization, changing the number of bunks on a given flight, as desired, without impacting main cabin 14 of aircraft 10, and thus without impacting the inner mold line layup mandrel used in manufacturing aircraft 10. The number of bunks (e.g., upper bunks 32 and/or lower bunks 34) may be selectively revised, and traded against cargo space (e.g., the number of bunks may be decreased and the amount of cargo space may correspondingly be increased, or vice versa) to accommodate different scenarios or flights for a given aircraft 10 (e.g., long haul, short haul, revenue cargo flights, etc.).

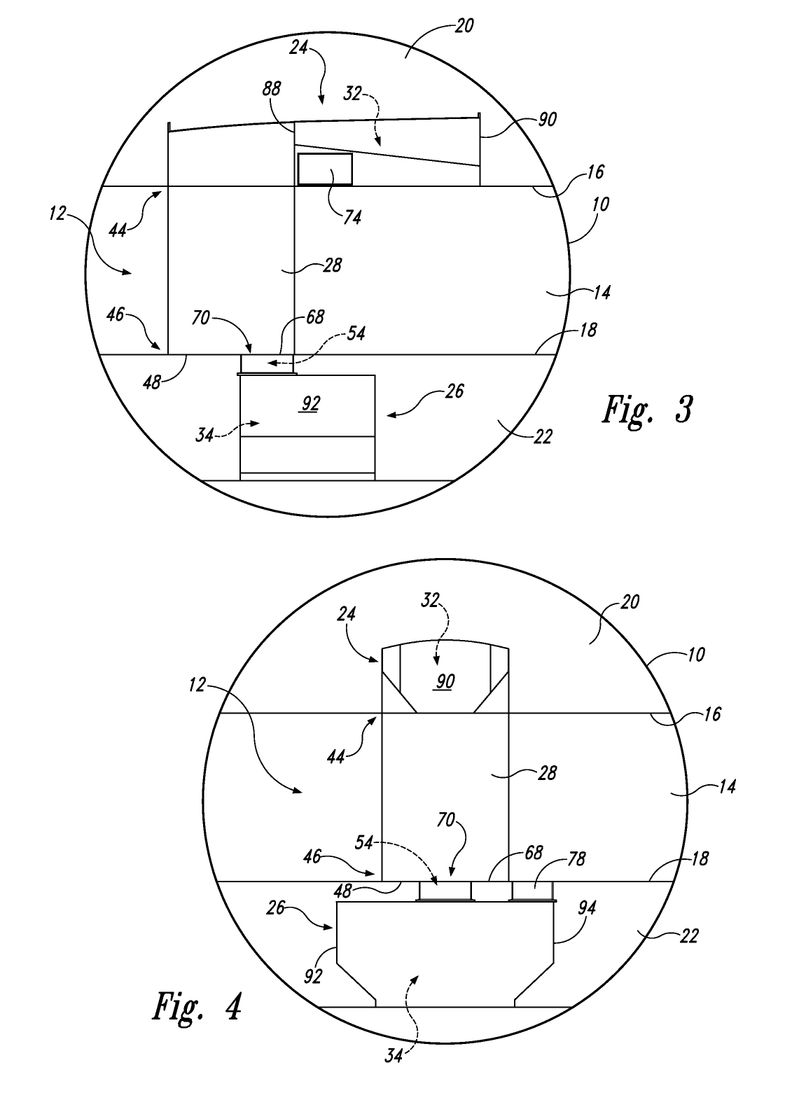

Turning now to FIGS. 3-10, illustrative non-exclusive examples of crew rest systems are illustrated. Where appropriate, the reference numerals from the schematic illustrations of FIGS. 1-2 are used to designate corresponding parts of FIGS. 3-10; however, the examples of FIGS. 3-10 are non-exclusive and do not limit crew rest systems to the illustrated embodiments of FIGS. 3-10. That is, crew rest systems 12 are not limited to the specific embodiments of the illustrated FIGS. 3-10 and may incorporate any number of the various aspects, configurations, characteristics, properties, etc. of crew rest systems that are illustrated in and discussed with reference to the schematic representations of FIGS. 1-2 and/or the embodiments of FIGS. 3-10, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to FIGS. 3-10, however, it is within the scope of the present disclosure that the previously discussed features, variants, etc. may be utilized with any of the embodiments of FIGS. 3-10.

FIGS. 3 and 4 schematically illustrate side elevation views of a representative crew rest system 12 according to the present disclosure. Crew rest system 12 is shown rotated 90 degrees with respect to one another in FIG. 3 and FIG. 4, but any orientation is possible within aircraft 10. As shown in FIG. 3, upper crew rest 24 may be positioned adjacent upper portion 44 of entrance enclosure 28, with entrance enclosure 28 being accessible from main cabin 14. Upper crew rest 24 may be positioned above ceiling 16, in crown portion 20 of aircraft 10, with upper bunk 32 of upper crew rest 24 extending longitudinally from an upper first end 88 adjacent entrance enclosure 28, to an upper second end 90. Lower crew rest 26 (e.g., lower bunk 34) may be oriented approximately perpendicularly to upper bunk 32), such that lower bunk extends longitudinally from a lower first end 92 to a lower second end 94. In other examples, upper bunk 32 and lower bunk 34 may be arranged approximately parallel to one another, or in any other orientation with respect to one another. As shown in FIGS. 3 and 4, lower crew rest 26 may be positioned beneath floor 18 of main cabin 14, in cargo area 22 of aircraft 10. Base 48 of entrance enclosure 28 of crew rest system 12 may be coupled to floor 18 of main cabin 14. Adjacent lower portion 46 of entrance enclosure 28, lower crew rest 26 may be coupled to entrance enclosure 28. In some examples, access hole 70 may be formed through interior floor 68 of entrance enclosure 28, such as to allow access to lower access structure 54 leading down into lower crew rest 26. Upper secondary egress 74 (FIG. 3) and lower secondary egress 78 (FIG. 4) may provide a secondary access point from upper crew rest 24 and lower crew rest 26, respectively, into main cabin 14 of aircraft 10.

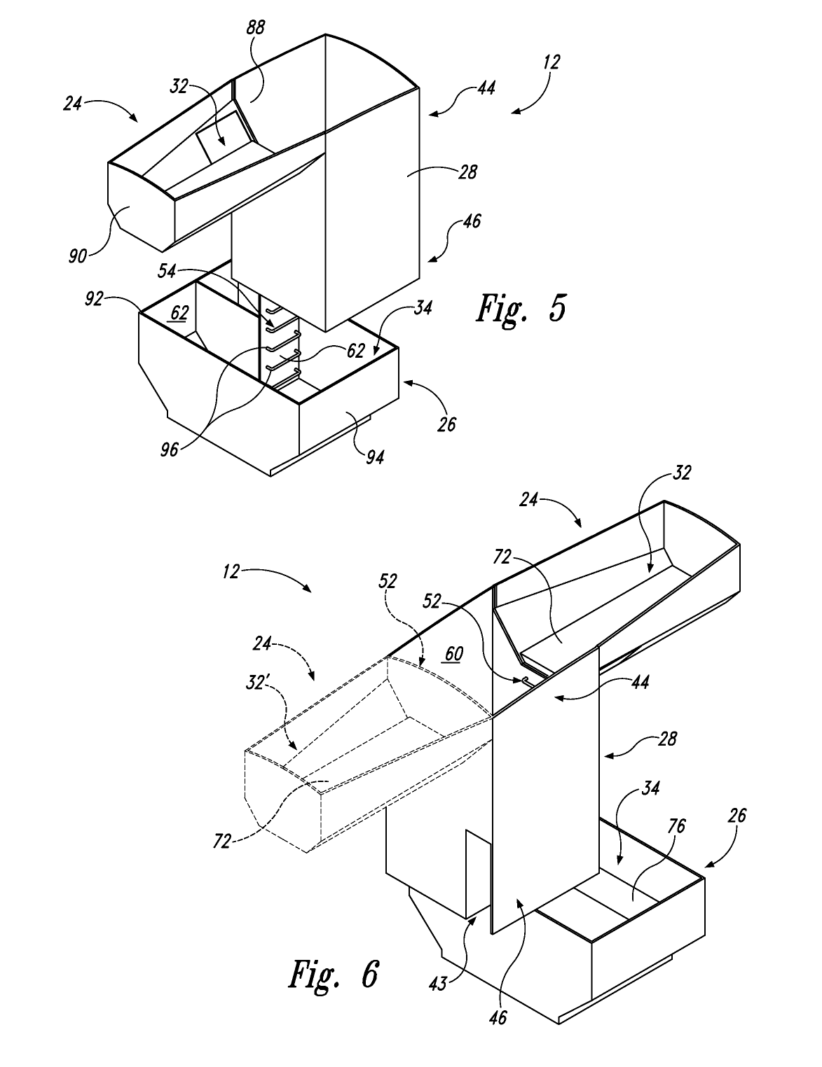

FIG. 5 shows a perspective view of one example of crew rest system 12 having upper crew rest 24 with upper bunk 32, and lower crew rest 26 with lower bunk 34. Upper crew rest 24 may extend longitudinally from upper first end 88 adjacent upper portion 44 of entrance enclosure 28, to upper second end 90. Lower crew rest 26 may be positioned beneath lower portion 46 of entrance enclosure 28, extending longitudinally from lower first end 92 to lower second end 94. Lower access structure 54 is shown in FIG. 5 in the form of a plurality of rungs 96 coupled to a respective lower interior wall 62 of lower crew rest 26. Such plurality of rungs 96 may enable a crew member to climb down into lower crew rest 26 (e.g., lower bunk 34) from entrance enclosure 28. As shown in FIG. 5, lower access structure 54 may extend up from lower crew rest 26 and into entrance enclosure 28, entering entrance enclosure 28 through interior floor 68 (e.g., via access hole 70) of entrance enclosure 28. From within entrance enclosure 28, a crew member may go up into upper crew rest 24 and rest in upper bunk 32, or the crew member may descend down to lower crew rest 26 and rest in lower bunk 34. In some crew rest systems 12, upper crew rest 24 may include a plurality of upper bunks 32, and/or lower crew rest 26 may include a plurality of lower bunks 34, such that a plurality of crew members may rest in upper crew rest 24, lower crew rest 26, or upper crew rest 24 and lower crew rest 26 simultaneously.

FIG. 6 illustrates a perspective view of an example of crew rest system 12, showing stowage area 43 that may be accessible from outside entrance enclosure 28. While not visible in FIG. 6, crew rest system 12 may include a walk-through door 42 (FIG. 2), which may be configured to allow a crew member to enter entrance enclosure 28, which, in turn, may allow the crew member to access upper crew rest 24 (e.g., via upper access structure 52, such as may be positioned on an interior wall 60 of entrance enclosure 28) and lower crew rest 26 (e.g., via lower access structure 54). Upper crew rest 24 is shown including one upper mattress portion 72, and lower crew rest 26 is shown including one lower mattress portion 76; however, upper crew rest 24 may include two or more upper mattress portions 72, and/or lower crew rest 26 may include two or more lower mattress portions 76, in some examples. As shown in FIG. 6, upper crew rest 24 may extend from the interior wall 60 opposite stowage area 43, in some examples. Additionally or alternatively, upper crew rest 24 may extend from any of the other interior walls 60, adjacent upper portion 44 of entrance enclosure 28. Similarly, lower crew rest 26 may be accessible via a lower access structure, which may be coupled to or positioned adjacent any of interior walls 60 of entrance enclosure 28, and lower crew rest 26 may be oriented in any direction relative to upper crew rest 24.

In some examples, upper bunk 32 may be a first upper bunk 32, and upper crew rest 24 may include one or more additional upper bunks 32. For example, as shown in dashed line in FIG. 6, a second upper bunk 32′ may extend from entrance enclosure 28, opposite first upper bunk 32. Each of first upper bunk 32 and second upper bunk 32′ may include one or more respective upper mattress portions 72, in which a crew member may rest. Other configurations are also possible. For example, second upper bunk 32′ may extend from any of the other interior walls 60, or second upper bunk 32′ may be positioned adjacent first upper bunk 32. Similarly, lower bunk 34 may be a first lower bunk 34, and lower crew rest 26 may include one or more additional lower bunks 34, each with one or more respective lower mattress portions 76 configured for a crew member to rest thereon.

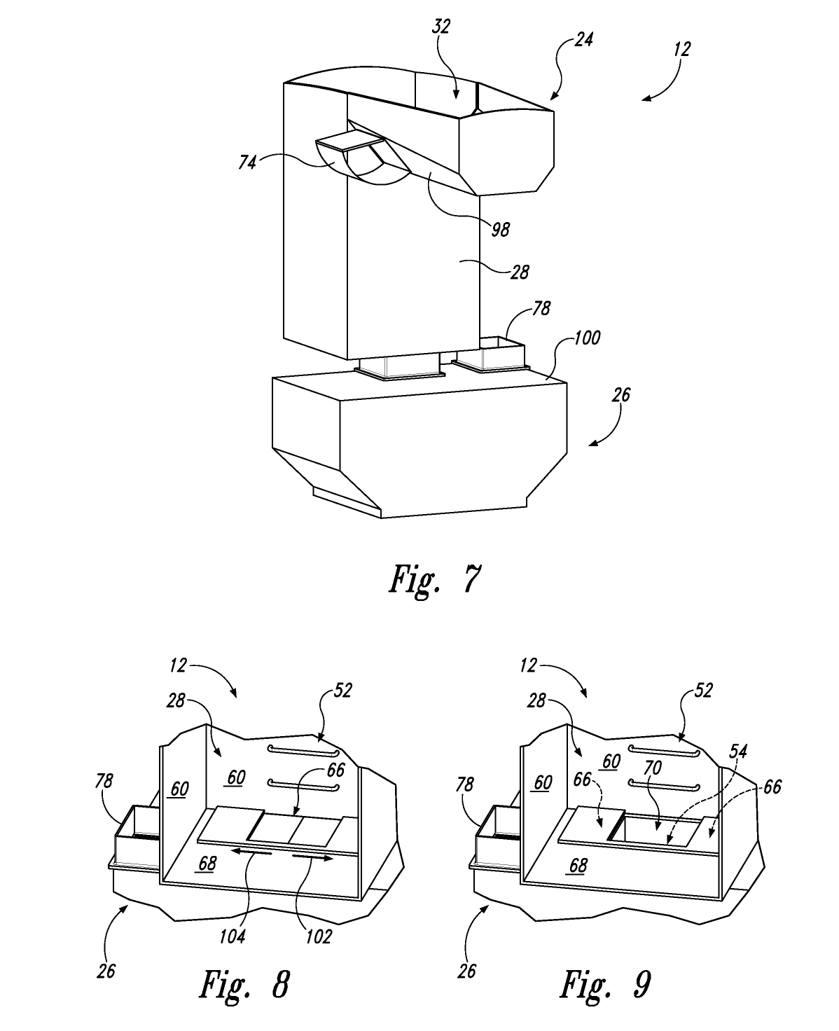

FIG. 7 illustrates a partial perspective view of an example of crew rest system 12, showing entrance enclosure 28, upper crew rest 24, and a portion of lower crew rest 26. FIG. 7 shows upper secondary egress 74 opening out from upper crew rest 24, and lower secondary egress 78 opening out from lower crew rest 26. While structures of the aircraft in which crew rest system 12 is located are not shown in FIG. 7, upper secondary egress 74 may be configured to open into the main cabin of the aircraft, such as into an overhead stowage bin area, and/or into the crown portion of the aircraft, to enable a crew member in upper bunk 32 to exit upper crew rest 24, such as in the event of an emergency, without going through entrance enclosure 28. In crew rest systems 12 having a plurality of upper bunks 32, each of the plurality of upper bunks 32 may include a respective upper secondary egress 74. Similarly, lower secondary egress 78 may be configured to open into the main cabin of the aircraft, such as through a floor panel in the cabin floor, and/or into the cargo area of the aircraft, to enable a crew member in lower bunk 34 to exit lower crew rest 26, such as in the event of an emergency, without going through entrance enclosure 28. In crew rest systems 12 having a plurality of lower bunks 34, each of the plurality of lower bunks 34 may include a respective lower secondary egress 78.

As shown in FIG. 7, upper secondary egress 74 may be in the form of, for example, a pivoting escape hatch, that may be configured to be opened from within upper bunk 32, such that it swings outward from an exterior portion 98 of upper bunk 32, thereby permitting exit from upper bunk 32, through upper secondary egress 74. Lower secondary egress 78 may be, for example, in the form of a hatch that opens up from an upper portion 100 of lower crew rest 26. Additionally or alternatively, lower secondary egress 78 may include a hatch or door formed in the floor of the main cabin of the aircraft, said hatch or door being accessible from lower crew rest 26 (e.g., via a door or hatch in upper portion 100 of lower crew rest 26, or lower crew rest 26 may simply be open, without a ceiling other than the main cabin floor, and/or base 48 of entrance enclosure 28, positioned above a portion of it). Other forms of secondary egress are also possible, such as secondary egresses that may include a sliding door, a hinged door, a staircase, a ladder, a hatch, a push-out window, and/or any other suitable mechanism or exit.

FIGS. 8 and 9 illustrate a portion of an example of crew rest system 12, showing a portion of entrance enclosure 28, and illustrating a close-up of articulating door 66 in a closed position (FIG. 8) and an open position (FIG. 9). In the closed position, articulating door 66 may block access hole 70 formed in interior floor 68 of entrance enclosure 28. Articulating door 66 may be configured to, in essence, form a portion of interior floor 68, such that a crew member may stand on top of articulating door 66 when the door is in the closed position. Articulating door 66, in the closed position, may prevent access to lower crew rest 26 through entrance enclosure 28. As shown in the example of FIGS. 8-9, articulating door 66 may be a two-part sliding door, with the two parts being configured to slide away from one another, as indicated by arrows 102, 104 (FIG. 8), in order to move to the open position (FIG. 9). In the open position, as shown in FIG. 9, articulating door 66 may be positioned within interior floor 68 of entrance enclosure 28. For example, articulating door 66 may be configured to open such that the two parts of the door slide away from one another, and into respective slots or recesses within interior floor 68.

Once articulating door 66 has been moved to the open position of FIG. 9, access hole 70 of entrance enclosure 28 may be exposed, and a crew member may be able to descend therethrough, down lower access structure 54, into lower crew rest 26. Thus, articulating door 66 may be configured to selectively permit access or block access to lower crew rest 26, depending on whether articulating door 66 is in the open or closed position. Articulating door 66 may be configured to be biased to the closed position, such that articulating door 66 automatically returns to and remains in the closed position when not actively being used to access lower crew rest 26. For example, articulating door 66 may be spring-loaded such that when any force exerted on articulating door 66 to open the door is removed, articulating door 66 automatically returns to the closed position.

FIGS. 8-9 illustrate articulating door 66 as a two-part sliding door, however, other configurations are also possible. For example, articulating door 66 may be a one-piece sliding door, a hinged door, a pivoting door, and/or any other type of device or mechanism that may be configured to selectively permit or block access to access hole 70, and thereby allowing access to lower crew rest 26, or other cargo area of the aircraft, as the case may be.

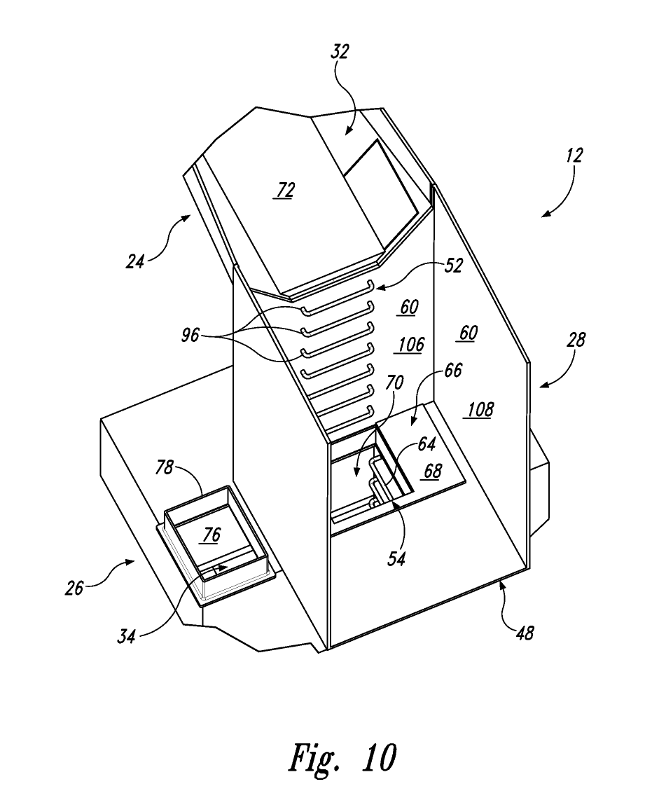

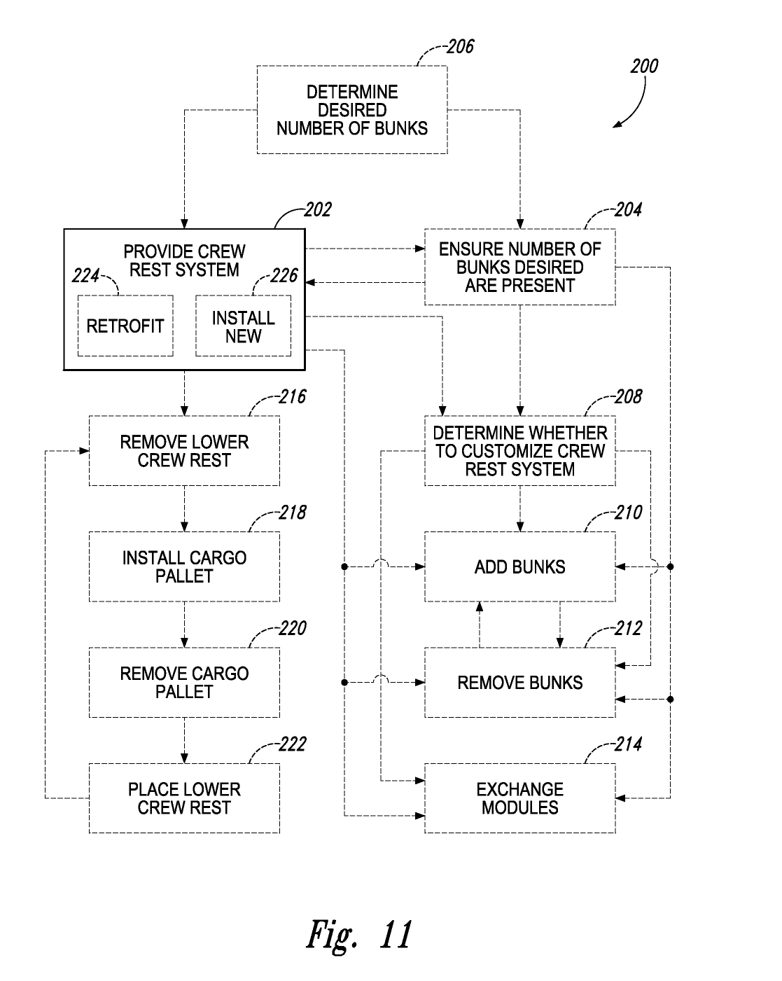

FIG. 10 illustrates a partial view of an example of crew rest system 12, with articulating door 66 in an open position, and showing upper access structure 52 and a portion of lower access structure 54. One of interior walls 60 of entrance enclosure 28 has been removed, to show more of the interior of entrance enclosure 28. Lower mattress portion 76 within lower bunk 34 may be visible through lower secondary egress 78 (which is shown open), as well as through access hole 70 formed through interior floor 68 of entrance enclosure 28. Once inside entrance enclosure 28, a crew member may climb upper access structure 52, in order to access upper bunk 32 and upper mattress portion 72 positioned therein. Upper access structure 52 is shown in FIG. 10 in the form of a plurality of rungs 96 coupled to a respective interior wall 60 of entrance enclosure 28. With articulating door 66 in the open position, the crew member may descend through access hole 70, using lower access structure 54 to enter lower bunk 34 of lower crew rest 26 (or to enter the cargo area of the aircraft).

As shown in FIG. 10, upper access structure 52 and lower access structure 54 may be discontinuous in alignment. In other words, upper access structure 52 and lower access structure 54 may be positioned adjacent or coupled to different respective interior walls 60 of entrance enclosure 28. For example, in FIG. 10, upper access structure 52 may be coupled to a north interior wall 106 of entrance enclosure 28, while lower access structure 54 may be oriented to be substantially parallel to a different respective interior wall 60, such as an east interior wall 108 of entrance enclosure 28. Said another way, upper access structure 52 may define a first plane, such first plane being substantially parallel to an interior wall 60, such as north interior wall 106, whereas lower access structure 54 may define a second plane, such second plane being substantially parallel to a different respective interior wall 60, such as east interior wall 108. In some examples, the first plane and the second plane may be substantially perpendicular to one another. Upper end 64 of lower access structure 54 may be positioned adjacent access hole 70, base 48, and/or interior floor 68 of entrance enclosure 28, but in some examples, lower access structure 54 may not extend into entrance enclosure 28.

FIG. 11 schematically provides a flowchart that represents illustrative, non-exclusive examples of methods 200 of providing a crew rest for a flight crew of an aircraft, according to the present disclosure. In FIG. 11, some steps are illustrated in dashed boxes indicating that such steps may be optional or may correspond to an optional version of a method according to the present disclosure. That said, not all methods according to the present disclosure are required to include the steps illustrated in solid boxes. The methods and steps illustrated in FIG. 11 are not limiting and other methods and steps are within the scope of the present disclosure, including methods having greater than or fewer than the number of steps illustrated, as understood from the discussions herein.

Methods 200 of providing a crew rest (e.g., crew rest system 12) for a flight crew of an aircraft may include providing the crew rest system at 202 and ensuring that the crew rest system provides the desired number of crew rests (e.g., upper bunks and lower bunks) for a given flight at 204. Some methods 200 may include determining a total number of bunks (e.g., upper bunks 32 and/or lower bunks 34) desired for a given flight of an aircraft, at 206. Once the number of bunks desired for a given flight has been determined at 206, it can be determined at 208 whether the crew rest system should be modified or customized for a given flight, if desired or needed, in order to ensure that the crew rest system provides the desired number of bunks, as determined at 206. For example, one or more bunks may be added to the crew rest system at 210, one or more bunks may be removed from the crew rest system at 212, and/or one or more modules may be exchanged at 214 (e.g., a first upper crew rest may be removed and replaced with a second upper crew rest, and/or a first lower crew rest may be removed and replaced with a second lower crew rest).

Some methods 200 may include removing a lower crew rest at 216 and installing a cargo pallet or other cargo container at 218, in the space where the lower crew rest had been located (e.g., at least partially beneath the entrance enclosure of the aircraft). Some methods 200 may include removing a cargo pallet or other cargo container at 220, and placing a lower crew rest in the location the cargo pallet or cargo container had been located, at 222. In some methods, placing the lower crew rest in the cargo area at 222 may include using an existing cargo locking mechanism to secure the lower crew rest in place in the cargo area of the aircraft. The crew rest system may thus be selectively customized or modified in order to provide more or fewer bunks, or more or less cargo space, as desired for a given flight. Thus, the particular aircraft may be used for various types of flights, such as for cargo revenue, shorter trips with fewer crew members, and for longer trips with more crew members, while utilizing space efficiently and without reducing the number of passenger seats in the main cabin.

Providing the crew rest system at 202 to a given aircraft may include retrofitting the aircraft at 224. For example, presently disclosed crew rest systems may be installed into existing aircraft. Alternatively, presently disclosed crew rest systems may be installed in new aircraft at the time of manufacture or assembly of the aircraft, at 226.

Illustrative, non-exclusive examples of inventive subject matter according to the present disclosure are described in the following enumerated paragraphs:

A1. A crew rest system for an aircraft, the crew rest system comprising:

an upper crew rest configured to be positioned within a crown portion of the aircraft, the upper crew rest comprising at least one upper bunk configured for a crew member to rest therein;

a lower crew rest configured to be positioned within a cargo area of the aircraft, the lower crew rest comprising at least one lower bunk configured for a crew member to rest therein; and

an entrance enclosure accessible from a main cabin of the aircraft, the entrance enclosure being configured to selectively provide access to the upper crew rest and the lower crew rest.

A1.1 The crew rest system of paragraph A1, wherein the entrance enclosure is coupled to the upper crew rest and the lower crew rest.

A1.2. The crew rest system of paragraph A1 or A1.1, wherein the upper crew rest is removably coupled to the entrance enclosure.

A1.3. The crew rest system of any of paragraphs A1-A1.2, wherein the lower crew rest is removably coupled to the entrance enclosure.

A1.4. The crew rest system of any of paragraphs A1-A1.3, wherein the entrance enclosure is configured to adjoin the upper crew rest and the lower crew rest.

A1.5. The crew rest system of any of paragraphs A1-A1.4, wherein the entrance enclosure is configured to provide a path for a crew member to move from the upper crew rest to the lower crew rest without exiting the entrance enclosure, and vice versa.

A1.6. The crew rest system of any of paragraphs A1-A1.5, wherein the entrance enclosure is accessible from the main cabin of the aircraft via a walk-through door.

A1.7. The crew rest system of any of paragraphs A1-A1.6, wherein the entrance enclosure is accessible from a cockpit of the aircraft.

A1.8. The crew rest system of any of paragraphs A1-A1.7, wherein the upper crew rest is coupled to an upper portion of the entrance enclosure, the upper portion of the entrance enclosure being opposite a lower portion of the entrance enclosure, the lower portion being adjacent a/the floor of the main cabin of the aircraft.

A1.9. The crew rest system of any of paragraphs A1-A1.8, wherein the lower crew rest is adjacent a/the lower portion of the entrance enclosure, the lower portion of the entrance enclosure being opposite an/the upper portion of the entrance enclosure, the lower portion being adjacent a/the floor of the main cabin of the aircraft.

A2. The crew rest system of any of paragraphs A1-A1.9, wherein the upper crew rest is configured for placement adjacent an interior inner mold line of the aircraft.

A3. The crew rest system of any of paragraphs A1-A2, wherein the lower crew rest is configured to fit within a standard cargo container volume.

A4. The crew rest system of any of paragraphs A1-A3, wherein the lower crew rest is selectively removable from the cargo area of the aircraft.

A5. The crew rest system of any of paragraphs A1-A4, wherein removal of the lower crew rest from the aircraft permits placement of one or more of a cargo pallet and a cargo container in a space where the lower crew rest was located before removal.

A6. The crew rest system of any of paragraphs A1-A5, wherein the entrance enclosure comprises a base that is affixed to a/the floor of the main cabin of the aircraft.

A7. The crew rest system of any of paragraphs A1-A6, wherein the lower crew rest is configured to provide access to the cargo area of the aircraft, through the lower crew rest.

A8. The crew rest system of any of paragraphs A1-A7, wherein the at least one upper bunk comprises a plurality of upper bunks, each of the plurality of upper bunks being positioned within the crown portion of the aircraft.

A9. The crew rest system of any of paragraphs A1-A8, wherein the at least one lower bunk comprises a plurality of lower bunks, each of the plurality of lower bunks being positioned within the cargo area of the aircraft.

A10. The crew rest system of any of paragraphs A1-A9, wherein the crew rest system does not reduce the number of passenger seats in the aircraft.

A11. The crew rest system of any of paragraphs A1-A10, wherein the lower crew rest is configured to be positioned in a cargo location, and wherein the lower crew rest is configured to be secured within the cargo location using a cargo restraint.

A12. The crew rest system of any of paragraphs A1-A11, wherein the entrance enclosure is configured to provide a single, joint entrance enclosure entrance for the upper crew rest and the lower crew rest.

A13. The crew rest system of any of paragraphs A1-A12, wherein the at least one upper bunk comprises an upper mattress portion.

A14. The crew rest system of any of paragraphs A1-A13, wherein the at least one lower bunk comprises a lower mattress portion.

A15. The crew rest system of any of paragraphs A1-A14, wherein the crew rest system comprises an upper access structure configured to provide access from the entrance enclosure to the upper crew rest.

A15.1. The crew rest of paragraph A15, wherein the upper access structure comprises an upper ladder.

A16. The crew rest system of any of paragraphs A1-A15.1, wherein the crew rest system comprises a lower access structure configured to provide access from the entrance enclosure to the lower crew rest.

A17. The crew rest system of paragraph A16, wherein the lower access structure extends from a/the base of the entrance enclosure, the base being affixed to a/the floor of the main cabin of the aircraft, down into the lower crew rest.

A18. The crew rest system of paragraph A16 or A17, wherein the lower access structure comprises a lower ladder.

A18.1. The crew rest system of any of paragraphs A16-A18, wherein the entrance enclosure comprises an articulating door positioned to block the lower access structure, the articulating door being selectively openable to allow access to the lower access structure.

A18.2. The crew rest system of paragraph A18.1, wherein the articulating door is configured to bias into a closed position when not in use.

A19. The crew rest system of any of paragraphs A16-A18, wherein the entrance enclosure comprises a sliding door positioned to block the lower access structure, the sliding door being selectively openable to allow access to the lower access structure.

A20. The crew rest system of paragraph A19, wherein the sliding door is configured to bias into a closed position when not in use.

A20.1. The crew rest system of paragraph A20, wherein the sliding door is spring-loaded so that it is biased closed when not in use.

A21. The crew rest system of paragraph A15 or A15.1, and any of paragraphs A16-A20.1, wherein the upper access structure and the lower access structure are discontinuous in alignment.

A22. The crew rest system of paragraph A21, wherein a first plane of the upper access structure and a second plane of the lower access structure are oriented approximately perpendicular to one another.

A23. The crew rest system of any of paragraphs A1-A22, wherein the upper crew rest comprises an upper secondary egress configured to allow a crew member to exit the upper crew rest separately from the entrance enclosure.

A24. The crew rest system of paragraph A23, wherein the upper secondary egress comprises an upper escape hatch that provides access from the upper crew rest to an interior portion of the aircraft.

A25. The crew rest system of paragraph A24, wherein the upper escape hatch opens into a stowage bin area of the aircraft, thereby allowing access from the upper crew rest to the main cabin of the aircraft.

A26. The crew rest system of any of paragraphs A1-A25, wherein the lower crew rest comprises a lower secondary egress configured to allow a crew member to exit the lower crew rest separately from the entrance enclosure.

A27. The crew rest system of paragraph A26, wherein the lower secondary egress comprises a lower escape hatch that provides access from the lower crew rest to an interior portion of the aircraft.

A28. The crew rest system of paragraph A27, wherein the lower escape hatch opens into the main cabin of the aircraft, thereby allowing access from the lower crew rest to the main cabin of the aircraft.

A29. The crew rest system of any of paragraphs A1-A28, wherein the crew rest system is selectively customizable such that the number of upper bunks and the number of lower bunks may be selectively increased or decreased.

A30. The crew rest system of any of paragraphs A1-A29, wherein the entrance enclosure is a standard entrance enclosure that is modified to receive the upper crew rest and lower crew rest.

A31. The crew rest system of any of paragraphs A1-A30, wherein the entrance enclosure comprises a storage area configured to receive one or more personal articles from a crew member while the crew member is resting in the upper crew rest or the lower crew rest.

A32. The crew rest system of any of paragraphs A1-A31, wherein the entrance enclosure is positioned to extend from a/the floor of the main cabin of the aircraft, and up to the upper crew rest.

A33. The crew rest system of any of paragraphs A1-A32, wherein the entire lower crew rest is positioned below a/the floor of the main cabin of the aircraft.

A34. The crew rest system of any of paragraphs A1-A33, wherein the upper crew rest is formed integrally with the entrance enclosure.

A35. The crew rest system of any of paragraphs A1-A34, wherein the crew rest system is modular, such that the upper crew rest may be selectively removable from the entrance enclosure and replaced with a different respective upper crew rest.

A36. The crew rest system of any of paragraphs A1-A35, wherein the crew rest system is modular, such that the lower crew rest may be selectively removable from the entrance enclosure and replaced with a different respective lower crew rest.

A37. The crew rest system of any of paragraphs A1-A36, wherein the upper crew rest comprises at least a first upper crew rest and a second upper crew rest, the crew rest system being configured such that one of the first upper crew rest and the second upper crew rest is coupled to the entrance enclosure at a time, each of the first upper crew rest and the second upper crew rest being selectively removable from the entrance enclosure so that the other of the first upper crew rest and the second upper crew rest may alternately be coupled to the entrance enclosure, adjacent a/the upper portion of the entrance enclosure, and wherein the first upper crew rest is different from the second upper crew rest in at least one of shape, size, orientation, and number of bunks.

A38. The crew rest system of any of paragraphs A1-A37, wherein the lower crew rest comprises at least a first lower crew rest and a second lower crew rest, the crew rest system being configured such that one of the first lower crew rest and the second lower crew rest is coupled to the entrance enclosure at a time, each of the first lower crew rest and the second lower crew rest being selectively removable from the entrance enclosure so that the other of the first lower crew rest and the second lower crew rest may alternately be coupled to the entrance enclosure, adjacent a/the lower portion of the entrance enclosure, and wherein the first lower crew rest is different from the second lower crew rest in at least one of shape, size, orientation, and number of bunks.

A39. The crew rest system of any of paragraphs A1-A38, wherein the entrance enclosure further comprises a stowage area configured for storing one or more of a galley cart and emergency equipment.

B1. An apparatus including the crew rest system of any of paragraphs A1-A39, wherein the apparatus comprises an aircraft.

B2. The apparatus of paragraph B1, wherein the apparatus comprises a passenger aircraft.

B3. The apparatus of paragraph B1 or B2, wherein the apparatus is configured for flights of longer than 8 hours.

C1. A method of providing a crew rest for a flight crew of an aircraft, the method comprising:

providing the crew rest system of any of paragraphs A1-A39 in the aircraft; and

ensuring that the crew rest system provides the desired number of crew rests for a given flight of the aircraft, each of the crew rests being accessible through the entrance enclosure.

C1.1. The method of paragraph C1, further comprising determining a total number of bunks desired for a given flight of an aircraft.

C2. The method of paragraph C1 or C1.1, wherein the providing the crew rest system comprises retrofitting the aircraft with the crew rest system.

C3. The method of any of paragraphs C1-C1.1, wherein the providing the crew rest system comprises installing the crew rest system in the aircraft at the time of assembling the aircraft.

C4. The method of any of paragraphs C1-C3, further comprising customizing the crew rest system based on a determination of a total number of bunks desired for the given flight.

C5. The method of any of paragraphs C1-C4, further comprising removing the lower crew rest from the crew rest system.

C6. The method of any of paragraphs C1-05, further comprising installing one or more of a cargo pallet and a cargo container beneath the entrance enclosure instead of a lower crew rest.

C7. The method of any of paragraphs C1-C6, further comprising removing one or more of a/the cargo pallet and a/the cargo container from beneath the entrance enclosure, and replacing the cargo pallet or cargo container with the lower crew rest.

C8. The method of paragraph C7, further comprising securing the lower crew rest in place using a cargo pallet locking mechanism adjacent a cargo floor of the aircraft.

C9. The method of any of paragraphs C1-C8, further comprising providing a plurality of upper bunks in the upper crew rest.

C10. The method of any of paragraphs C1-C9, further comprising providing a plurality of lower bunks in the lower crew rest.

C11. The method of any of paragraphs C1-C10, further comprising adding one or more upper bunks to the crew rest system.

C12. The method of any of paragraphs C1-C11, further comprising removing one or more upper bunks from the crew rest system.

C13. The method of any of paragraphs C1-C12, further comprising adding one or more lower bunks to the crew rest system.

C14. The method of any of paragraphs C1-C13, further comprising removing one or more lower bunks from the crew rest system.

C15. The method of any of paragraphs C1-C14, further comprising exchanging a first upper crew rest module with a second upper crew rest module, the first upper crew rest module being different from the second upper crew rest module in at least one of size, shape, orientation, and number of bunks.

C16. The method of any of paragraphs C1-C15, further comprising exchanging a first lower crew rest module with a second lower crew rest module, the first lower crew rest module being different from the second lower crew rest module in at least one of size, shape, orientation, and number of bunks.

D1. Use of the crew rest system of any of paragraphs A1-A39 to provide a crew rest station for a flight crew on an aircraft.

E1. Use of the crew rest system of any of paragraphs A1-A39 to provide a single entrance enclosure that allows access to both the upper crew rest and the lower crew rest of the crew rest system.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus. As used herein, the terms “north” and “east” are used to designate relative positions in a particular view of a figure, and do not limit such respective positions to any cardinal direction.

The various disclosed elements of apparatuses and systems and steps of methods disclosed herein are not required to all apparatuses, systems, and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus, system, or method. Accordingly, such inventive subject matter is not required to be associated with the specific apparatuses, systems, and methods that are expressly disclosed herein, and such inventive subject matter may find utility in apparatuses, systems, and/or methods that are not expressly disclosed herein.

1. A crew rest system for an aircraft, the crew rest system comprising:
an upper crew rest configured to be positioned within a crown portion of the aircraft, the upper crew rest comprising at least one upper bunk configured for a crew member to rest therein;
a lower crew rest configured to be positioned within a cargo area of the aircraft, the lower crew rest comprising at least one lower bunk configured for a crew member to rest therein; and
an entrance enclosure accessible from a main cabin of the aircraft, the entrance enclosure being configured to adjoin the upper crew rest and the lower crew rest, and to selectively provide access to the upper crew rest and the lower crew rest.

2. The crew rest system according to claim 1, wherein the entrance enclosure is integrally formed with the upper crew rest.

3. The crew rest system according to claim 1, wherein the lower crew rest is removably coupled to the entrance enclosure, such that the lower crew rest is configured to be selectively removed from the cargo area of the aircraft and replaced with one of a cargo pallet and a cargo container.

4. The crew rest system according to claim 1, wherein the entrance enclosure is configured to provide a path for a crew member to move from the upper crew rest to the lower crew rest without exiting the entrance enclosure, and vice versa.

5. The crew rest system according to claim 1, wherein the upper crew rest is coupled to an upper portion of the entrance enclosure, the upper portion of the entrance enclosure being opposite a lower portion of the entrance enclosure, the lower portion being adjacent a floor of the main cabin of the aircraft, and wherein the lower crew rest is adjacent the lower portion of the entrance enclosure.

6. The crew rest system according to claim 1, wherein the at least one upper bunk comprises a plurality of upper bunks, each of the plurality of upper bunks being positioned within the crown portion of the aircraft.

7. The crew rest system according to claim 1, wherein the at least one lower bunk comprises a plurality of lower bunks, each of the plurality of lower bunks being positioned within the cargo area of the aircraft.

8. The crew rest system according to claim 1, wherein the crew rest system comprises an upper access structure configured to provide access from the entrance enclosure to the upper crew rest, and wherein the crew rest system further comprises a lower access structure configured to provide access from the entrance enclosure to the lower crew rest.

9. The crew rest system according to claim 8, wherein the entrance enclosure comprises an articulating door configured to block the lower access structure, the articulating door being selectively openable to allow access to the lower access structure, wherein the articulating door is configured to bias into a closed position when not in use.

10. The crew rest system according to claim 1, wherein the upper crew rest comprises an upper secondary egress configured to allow a crew member to exit the upper crew rest separately from the entrance enclosure, and wherein the lower crew rest comprises a lower secondary egress configured to allow a crew member to exit the lower crew rest separately from the entrance enclosure.

11. The crew rest system according to claim 1, wherein the crew rest system is selectively customizable such that a number of upper bunks and a number of lower bunks may be selectively changed.

12. The crew rest system according to claim 1, wherein the crew rest system is modular, such that the upper crew rest may be selectively removable from the entrance enclosure and replaced with a different upper crew rest.

13. The crew rest system according to claim 1, wherein the crew rest system is modular, such that the lower crew rest may be selectively removable from the entrance enclosure and replaced with a different lower crew rest.

14. An aircraft, wherein the aircraft comprises the crew rest system according to claim 1.

15. A method of providing a crew rest system for a flight crew of an aircraft, the method comprising:
providing a crew rest system, the crew rest system comprising:
an upper crew rest configured to be positioned within a crown portion of the aircraft, the upper crew rest comprising at least one upper bunk configured for a crew member to rest therein;
a lower crew rest configured to be positioned within a cargo area of the aircraft, the lower crew rest comprising at least one lower bunk configured for a crew member to rest therein; and
an entrance enclosure accessible from a main cabin of the aircraft, the entrance enclosure being configured to adjoin the upper crew rest and the lower crew rest, and to selectively provide access to the upper crew rest and the lower crew rest; and
ensuring that the crew rest system provides a desired number of crew rests for a given flight of the aircraft, each of the desired number of crew rests being accessible through the entrance enclosure.

16. The method according to claim 15, wherein the providing the crew rest system comprises retrofitting the aircraft with the crew rest system.

17. The method according to claim 15, wherein the providing the crew rest system comprises installing the crew rest system in the aircraft during assembly of the aircraft.

18. The method according to claim 15, further comprising customizing the crew rest system based on a determination of a total number of bunks desired for a given flight.

19. The method according to claim 15, further comprising removing the lower crew rest from the crew rest system.

20. The method according to claim 19, further comprising installing one of a cargo pallet and a cargo container beneath the entrance enclosure after the removing the lower crew rest.
